(19) United States
(12) Patent Application Publication
(10) Pub. No.: US 2004/0063813 A1
(43) Pub. Date: Apr. 1, 2004

(54) Powder coating compositions containing reactive nanoparticles

(76) Inventors: Bin Wu, Marietta, GA (US); Zhikai Wang, Roswell, GA (US)

Correspondence Address: Wenderoth Lind & Ponack, Suite 800, 2033 K Street N W, Washington, DC, 20006, US

(21) Appl. No.: 10/450,399

(22) PCT Filed: Dec. 10, 2001
(86) PCT No.: PCT/US01/47240

(51) Int. Cl. C08K 3/18; C08K 9/00

(52) U.S. Cl. 523/200; 524/430

(57) ABSTRACT

A powder coating composition comprising reactive nanoparticles and a thermocurable or radiation curable resin. The nanoparticles impart a wide range of enhanced properties to the compositions such as hardness and abrasion resistance.

### BACKGROUND OF THE INVENTION

This invention relates to the utilization of reactive nanoparticle in thermoset and radiation curable powder coatings for the enhancement of various properties.

Conventional powder coatings have many shortcomings in their process and application properties. For example, in order to obtain a smooth film, powders must flow well at cure temperature, and many powder coating systems do not flow well due to their high melt viscosity. One normal way to improve the flow is to use resin binders of low melt viscosity. However, low-viscosity resins usually also have low glass transition temperatures, which diminishes storage stability as sintering increases. A typical powder coating formulation must have a softening point higher than 40° C. to prevent sintering and maintain sufficient storage stability.

Conventional powder coatings also suffer from low surface hardness, as well as low abrasion and stain resistance. These shortcomings prevent powder coatings from further penetrating into many application areas of conventional solvent based coatings.

The use of inorganic fillers to improve properties of coatings is well known. However, there are many limitations in using fillers. First of all, larger quantities of fillers must be used to obtain good results, and this can change other properties of powder coatings. For example, the melt viscosity can be increased dramatically. Secondly, it may be difficult to incorporate large quantities of fillers into coating compositions desired by coating performances due to the difficulty of the dispersion process and dispersion stability problems, mainly because of the filler's incompatibility with organic resins and hardeners.

Nanoparticles discussed in the current invention are inorganic particles with diameters in the range of 1 to 400 nanometers. It is a known art that an inorganic nanoparticle can be surface modified to be compatible with organic polymers. The modified nanoparticles were then incorporated into polymeric matrix as “nano-fillers.

However, the nanoparticles mentioned above are only physically, not chemically bonded to the coating matrix. In order for the coatings to have maximum enhanced properties without sacrificing their inherent ones, connections between inorganic nanoparticles and organic polymers via chemical bonds must exist. Lack of reactive groups on the surface of the above-mentioned nanoparticles makes them non-polymerizable during the curing process of the coatings. As a result, these nanoparticles do not participate in the polymerization reactions and will not become part of the chemical network after curing. Thus the nanoparticles are only physically dispersed in the cured coatings, which can result in two scenarios:

1) The coatings are not completely cured. This can result in the loss of impact resistance, chemical resistance, flexibility, and many other properties.

2) Enhancement of the coating properties by nanoparticles may not be maximized. The inorganic nanoparticles must become part of the chemical network in the coatings to be fully effective.

Therefore, in the current invention, reactive functional groups are chemically attached onto the surface of the inorganic nanoparticles. The inorganic nanoparticles that are used in this invention include but not limit to silicone dioxide, titanium dioxide, aluminum oxide and other metal, semi-metal or non-metal dioxide or salts. Examples of reactive functional groups are epoxy, carboxyl, hydroxyl, anhydride (carboxylic), vinyl, acrylate or methacrylate, etc.

In the following reference: S. Sepeur, et al., Mater. Res. Soc. Symp. Proc., Vol., 576, (1999), a sol-gel process was described in which a hybrid of thermoset resin/SiO₂ nanoparticles was produced in situ. A pencil hardness of 4H was achieved. However, this process has the following disadvantages: 1) The synthesis of the resin requires a large portion of organo-silicon compounds, which increases raw material cost; 2) The method is not compatible with current powder coating manufacturers processes; 3) Hydrolytic stability of the coatings is a concern.

In U.S. Pat. Nos. 5,385,776, 5,514,734 and 5,747,560 nanocomposites employing thermoplastic resins, e.g. polyamide, polyolefins, vinyls, plasticized PVC, etc., are disclosed as useful in powder coating. However, thermoplastics based powder coating compositions have significant limitations as will now be discussed.

Disadvantages of Thermoplastic Based Powder Coatings

Heat curable powder coatings can be categorized into two broad divisions: thermoplastic and thermocurable. Thermoplastic powders do not chemically react during application or baking. Therefore, these materials will remelt after cooling when heat is applied. Due to their nature and application limits, thermoplastic powders are generally used only for functional coatings.

Unlike thermoplastic coatings, thermocurable powder coatings will chemically react during baking to form a polymer network, which is more resistant to coating breakdown. Additionally thermocurable powder coatings will not remelt after cooling when heat is applied. Even though there is widespread use of functional powder coatings for protective purposes, the vast majority of powders are utilized in decorative applications where color, gloss, and appearance may be the primary attributes. That is why the powders used in the industry are predominantly thermocurable powder coatings.

Polyamide is a typical thermoplastic powder coating resin. Examples of the disadvantages of a thermoplastic powder coating system are:

High Cost

High process temperatures

High viscosity

Poor adhesion to most substrates

Low thermal stability

Not easy to achieve thin films

Process Limit—can only be applied by fluidized bed application equipment.

Only limited to functional coatings.

French patent FR 2,150,474 describes a method of using nano-sized silicate for the improvement of powder coating properties. The same technology was used in UK patent GB 2,311,527. However, since these nanoparticles do not possess reactive functional groups, they do not participate in the crosslinking reactions during the curing of the coatings, and as a result, the properties that could be improved are very limited.

Radiation curable powder coatings have good potentials and have attracted much industrial attention in recent years. The coatings are cured by electron beam (EB) or UV light via cationic or free-radical photopolymerization. Heat is applied by means of infrared light to cause the coating to melt and flow. The main advantages of radiation curable powder coatings are as the following:

1) Energy saving.

2) High line speed.

3) Low cure temperatures, which makes it possible to coat on heat sensitive substrates such as wood, plastic and medium density fiber (MDF) board.

Radiation curable powder coatings also suffer from low surface hardness, poor appearance, low abrasion resistance and solvent resistance. As will be seen later, one of the objects of this invention is to use reactive nanoparticles to enhance all these properties of the radiation curable powder coatings.

### SUMMARY OF THE INVENTION

Due to the nature of powder coatings and the characteristics of the reactive nanoparticles, there is great potential in using them to enhance various properties of powder coatings; Therefore, the first object of the invention is to provide a composition, which incorporates certain types of reactive nanoparticles and thermocurable or radiation curable resins for making powder coatings with improved pencil hardness. Examples of thermocurable resins are polyesters, epoxy and acrylics. Examples of radiation curable resins are vinyl ethers and unsaturated polyesters. Such resins and nanoparticles are employed in the other object applications set forth below.

The second object of the invention is to provide a composition, which incorporates certain types of reactive nanoparticles for making powder coatings with improved scratch resistance.

Another object of the invention is to provide a composition, which incorporates certain types of reactive nanoparticles for making powder coatings of low viscosity, and better flow-out property, which results in finished films of improved smoothness and distinctiveness of image (DOI).

Another object of the invention is to provide a composition, which incorporates certain types of reactive nanoparticles for making powder coatings with improved abrasion/wear resistance.

Another object of the invention is to provide a composition, which incorporates certain types of reactive nanoparticles for making powders with increased glass transition temperature and thus more desirable storage stability.

Another object of the invention is to provide a composition, which incorporates certain types of reactive nanoparticles for making powder coatings with improved solvent/chemical resistance.

Another object of the invention is to provide a composition, which incorporates certain types of reactive nanoparticles for making powder coatings with improved impact resistance.

Another object of the invention is to provide a composition, which incorporates certain types of reactive nanoparticles for making powder coatings with improved barrier properties.

Another object of the invention is to provide a composition, which incorporates certain types of reactive nanoparticles for making powder coatings with improved fire retardancy and heat resistance.

Another object of the invention is to provide a composition, which incorporates certain types of reactive nanoparticles for making powder coatings with higher refractive index and transparency.

Another object of the invention is to provide a composition, which incorporates certain types of reactive nanoparticles for making powder coatings with improved stain resistance.

Another object of the invention is to provide a composition, which incorporates certain types of reactive nanoparticles for making powder coatings with controllable gloss.

Another object of the invention is to provide a composition, which incorporates certain types of reactive nanoparticles for making powder coatings with controllable surface tension.

Another object of the invention is to provide a composition, which incorporates certain types of reactive nanoparticles for making powder coatings with controllable film permeability.

The powder coating compositions described above may be processed using conventional methods, e.g. premixing and extrusion. Powders may be applied onto various substrates such as metals, MDF board and wood, using conventional and unconventional methods. Examples of conventional application methods are electrostatic spray (Corona charging or Tribo charging), fluidized bed and flamespraying. Curing may be achieved by thermal heating, induction coating, infrared heating, ultraviolet (UV) and electron beam (EB) radiation.

Other objects of the present invention will become apparent to people skilled in the art from the description of the invention that follows and from the disclosed preferred embodiment thereof.

The present invention enables the aforementioned objects. Indeed, the invention provides compositions containing reactive nanoparticles for powder coatings with improved properties. Chemically attached to the surface of said reactive nanoparticles are reactive functional groups. Examples of these reactive functional groups are epoxy, hydroxyl, carboxyl and anhydride groups or double bonds. It is noted that these examples listed here are for-demonstration purposes and are not limiting.

The present powder coating systems are either of the thermocurable or radiation curable types.

### DETAILED DESCRIPTION

A typical thermosetting powder coating formulation consists of the following ingredients:

Resin(s)

Crosslinker(s)

Pigments

Flow Agent

Degassing Agent

Curing Catalyst

Stabilizers

Other performance-enhancing additives.

Typical resins are:

Polyesters

Epoxies

Acrylics

These resins are formulated with different crosslinkers (curatives or hardeners) for different application needs. The most commonly used crosslinkers are:

Amines

Epoxy resins

Triglycidyl isocyanurate (TGIC)

Carboxylic acids

Anhydrides

Blocked isocyanates

Melamines

Glycoluril

Hydroxyalkylamide (e.g. Primid)

Blocked isocyanates

Another type of powder coating is the radiation-curable (e.g. UV and Electron Beam) system, which consists of one or more resins and photo initiators and other necessary ingredients used in thermosetting coating systems.

An example of radiation curable powder coating system contains an unsaturated polyester with a molecular weight in the range of 1,000 to. 10,000, a photoinitiator and other ingredient typically used in a conventional powder coating formulation. An example of said unsaturated polyester is UCB's UVECOAT 2000. An example of the photoinitiator is Ciba's Irgacure 819.

The following summarizes the experimental procedures and the results obtained. It should be noted that the procedures and formulations used here only serve as examples of the invention. The scope of the invention is not to be limited to these examples.

As an embodiment of the invention, the nanoparticles are treated with reactive or polymerizable functional groups such as epoxy, carboxyl, hydroxyl, anhydride (carboxylic), vinyl, acrylate and methacrylate, etc.

Typically, the present compositions are prepared by melt blending or melt extrusion.

In melt blending, a resin-nanoparticle mixture is stirred at an elevated temperature.

In melt extrusion, all of the ingredients of a powder formulation including resin, hardener, pigment, catalyst and the nanoparticles are admixed and extruded at elevated temperatures.

Materials

Aluminum Oxide C, a non-reactive nanoparticle obtained from Degussa-Huls.

Z-6040, a surface modifying agent with epoxy functionality obtained from Dow Corning.

Crylcoat 3004, an acid functional polyester powder resin produced by UCB Chemicals Corporation. AN=70 mg KOH/g.

UVECOAT 2000, a UV powder coating resin produced by UCB Chemical Corporation.

RX-01387, an Al₂O₃ nanoparticle functionalized with epoxy groups.

RX-05614, an Al₂O₃ nanoparticle functionalized with epoxy groups.

RX-05613, a TiO₂ nanoparticle functionalized with double bonds.

The following is a generalized procedure for making a functionalized nanoparticle, such as RX-01381, RX-05613 and RX-05614:

In a three-neck flask, disperse certain amount of a commercial grade nanoparticle (e.g. Al₂O₃) in powdered form in methanol by agitating for one hour. The weight ratio of methanol over the nanoparticle is approximately 20-50. Dissolve certain amount of Z-6040 in methanol. The amount of Z-6040 is between 0.1 and 0.5% by weight of that of the nanoparticle. With agitation, the Z-6040/methanol solution was dropwisely added to the nanoparticle dispersion. Transfer the content in the three-neck flask to a single neck flask. Reflux the mixture in the single neck flask at 40-60° C. for approximately 2 hours. The reflux temperature depends on the type of surface modifiers. Allow methanol to evaporate. Dry the product at 110° C. for 24 hours.

Melt Blending

For Thermocurable Powder Coating System:

3,556 g of Crylcoat 370 was transferred to a 10-liter round-bottom flask. The resin was heated to 160-200° C. until completed melted. The temperature was maintained at 160-200° C. while the molten resin was stirred. Appropriate amount of a nanoparticle of epoxy functionality was added into the flask. The resin and nanoparticle mixture was stirred at 160-200° C. for one hour before poured into an aluminum pan.

For Radiation Curable Powder Coating System:

3,000 g of UVECOAT 2000 was transferred to a 10-liter round-bottom flask. The resin was heated to 140-180° C. until completed melted. The temperature was maintained at 140-180° C. while the molten resin was stirred. Appropriate amount of a nanoparticle of double bond functionality was added into the flask. The resin and nanoparticle mixture was stirred at 140-180° C. for one hour before poured into an aluminum pan.

Melt Extrusion

For Thermocurable Powder Coating Systems:

All ingredients of a powder formulation including the resin, pigment, degassing agent, catalyst and a certain type of reactive nanoparticle were mixed in a Prism Pilot 3 High-Speed Premixer. Premix speed was 2000 RPM and total mixing time was 4 minutes. The premixed mixture was then extruded in a Prism 16 PC twin screw extruder at approximately 110° C. The extrudate was cooled at −30° C. for 24 hours. The cooled flakes were pulverized in a Brinkmann high-speed grinder, sieved with a 140-mesh sieve into the filial powder. The powder was applied electrostatically onto aluminum, steel or MDF substrates. The panels were baked at temperatures between 100° C. and 200° C. for 15-40 minutes.

For Radiation Powder Coating Systems:

All ingredients of a radiation curable powder formulation including the resin, photoinitiator, pigment, degassing agent, and a certain type of reactive nanoparticle were mixed in a Prism Pilot 3 High-Speed Premixer. Premix speed was 2000 RPM and total mixing time was 4 minutes. The premixed mixture was then extruded in a Prism 16 PC twin screw extruder at approximately 110° C. The extrudate was cooled at −30° C. for 24 hours. The cooled flakes were pulverized in a Brinkmann high-speed grinder, sieved with a 140-mesh sieve into the final powder. The powder was applied electrostatically onto aluminum, steel or MDF substrates. The panels were cured under UV or EB lights with appropriate heating (e.g. an IR light).

Property Test

Distinctness of image (DOI): The procedure is listed in Instruments for Research and Industry Application Data Sheet included with the Model GB 11-DOI Glow Box.

Pencil Hardness was measured according to ASTM D 3363. Pencil Scratch and Gouge Hardness were measured.

Taber abrasion was measured according to ASTM D 4060.

Scratch resistance was measured according to the description below.

One common method of assessing the scratch resistance of a coating is to rub 0000 grade steel wool across the coating surface. The following technique uses a standard weight hammer to apply the force between the steel wool and the coating, increasing the reproducibility between operators. Cloth (cheesecloth or felt is ideal) is attached to the curved face of a 32 ounce ball peen hammer. A piece of 0000 steel wool approximately one inch in diameter is placed on the coating surface to be tested. The cloth covered curved face of the hammer is placed directly on-the steel wool and, with the handle of the hammer held as close to horizontal as practical and no downward pressure exerted, the hammer drawn back and forth across the coating. The cloth on the hammer face provides a grip between the hammer and steel wool. Consequently, the steel wool is rubbed across the coating surface with equal force along a path. The path length is typically several inches and each back and forth motion is counted as a cycle. Care is taken to secure the coated substrate firmly and to maintain the same path for each cycle. After a predetermined number of cycles are completed, the coating surface is examined for changes in appearance such as an increase in haze resulting from scratches in the surface. A number, usually 1 to 5, is then given to rank the scratch resistance. 1 has the lowest resistance and 5 the highest. Alternately, cycles are continued and counted until the first visible sign of a change in the appearance of the coating.

600 and 200 gloss and haze were measured on a BYK-Gardner Haze-Gloss Meter.

Flexibility evaluation was based on ASTM D 4145 and T-bend was reported.

Reverse impact resistance was measured according to ASTM G 14.

Methyl ethyl ketone (MEK) resistance was measured as MEK double rubs in accordance to ASTM D 4752.

Marker resistance test was carried out using markers of red, green, blue and black colors. After being marked with the four colors, the panel was allowed to dry for 30 minutes. Methanol, toluene, acetone and MEK were used to wipe the marks. Marker resistance of the coatings were rated on a 1-5 scale, with 5 being the highest and 1 the lowest, based on how much residue of the mark was left on the coatings after the wiping.

Property Improvement for Thermoset Powder Coatings

Formulations of thermoset powder coatings were listed in Table 1. All the properties tested were included in Table 2.

As can be seen in Table 2, the addition of RX 01387 and RX 05614 improved appearance of coatings, as evidenced by the increased gloss and DOI and the decreased haze.

The addition of RX 01387 and RX 05614 also increased the surface hardness, Taber abrasion and scratch resistance.

One needs to note that although aluminum oxide nanoparticles containing no reactive groups also improved-hardness and scratch resistance (entry 2 in Table 1 and 2), other important properties such as appearance, impact resistance, solvent resistance, abrasion resistance and flexibility of the coatings were sacrificed. This was due to the fact that non-reactive nanoparticles do not participate in the crosslinking reactions in the curing process, therefore not becoming part of the chemical network structure. Incomplete cure may have been resulted.

Meanwhile, the reactive nanoparticle, particularly RX 05614, improved many properties of the powder coatings while maintaining others. This is indeed one advantage of the reactive nanoparticles over non-reactive ones.

TABLE 1
Formulation of Thermoset Powder Coatings

| | Resin | Hardener | Nanoparticle | Flow- | Degassing | Pigment |
|---|---|---|---|---|---|---|
| No. | wt % | wt % | wt % | agent | Agent | (TiO2) |
| 1 | CC3004 | EPON 2002 | — | 1.0 | 0.4 | 30.0 |
| | 34.3 | 34.3 | — | | | |
| 2 | CC3004 | EPON 2002 | Al₂O₃C | 1.0 | 0.4 | 30.0 |
| | 34.3 | 34.3 | 3.7 | | | |
| 3 | CC3004 | EPON 2002 | RX 01387 | 1.0 | 0.4 | 25.0 |
| | 35.7 | 32.9 | 5.0 | | | |
| 4 | CC3004 | EPON 2002 | RX 05614 | 1.0 | 0.4 | 30.0 |
| | 34.3 | 34.3 | 3.7 | | | |

TABLE 2
Properties of Thermoset Powder Coatings

| Formulation Number | | 1 | 2 | 3 | 4 |
|---|---|---|---|---|---|
| Gloss | 60° | 99.4 | 97.9 | 98.4 | 101.0 |
| | 20° | 94.9 | 91.0 | 91.5 | 97.3 |
| Haze | | 52.6 | 86.0 | 52.0 | 38.1 |
| DOI | | 70 | 60 | 80 | 80 |
| Pencil | scratch | HB | 3H | 2H | 3H |
| Hardness | gauge | 3H | 3H | 4H | 4H |

| | | | | |
|---|---|---|---|---|
| MEK double rubs | >200 | 35 | >200 | >200 |
| Taber Abrasion (wt. loss | 233 | 450 | — | 191 |
| in mg after 1000 cycles) | | | | |
| Impact resistance (in. lb) | 160 | 0 | 160 | 160 |
| T-bend | 0T | 2T | 0T | 0T |
| Steel wool rub rating | 1 | 2 | 1 | 3 |

Stain resistance of the powder coatings was also increased by the addition of the reactive nanoparticles. Table 3 compares the results of marker resistance on powder coating 1 (control) and 4 (with RX 05614). As can be seen in Table 3, RX 05614 showed significant increase in stain resistance, particularly in the cases of acetone and MEK.

TABLE 3
Results of Marker Resistance Tests

| | Red | | Green | | Blue | | Black | |
|---|---|---|---|---|---|---|---|---|
| | Formula | Formula | Formula | Formula | Formula | Formula | Formula | Formula |
| Solvent | 1 | 4 | 1 | 4 | 1 | 4 | 1 | 4 |
| Methanol | 5 | 5 | 4 | 4 | 5 | 5 | 4 | 4 |
| Acetone | 2 | 4 | 3 | 4 | 2 | 3 | 2 | 3 |
| Toluene | 4 | 4 | 5 | 5 | 3 | 3 | 2 | 2 |
| MEK | 2 | 4 | 2 | 5 | 1 | 3 | 1 | 2 |

Property Improvement for Radiation Curable Powder Coatings

Table 4 shows two UV powder formulations, U1 and U2. U1 is a standard formulation based on UVECOAT 2000 and U2 contains 4% of RX 05613, a nanoparticle functionalized with double bonds.

As can be seen from Table 4, appearance, surface hardness and solvent resistance were all increased by the addition of RX 05613.

TABLE 4
Formulation of UV Powder Coatings

| Formu- | | | Nano- | | |
|---|---|---|---|---|---|
| lation | Resin | Photoinitiator | particle | Degassing | Pigment |
| No. | wt % | wt % | wt % | Agent | (TiO₂) |
| U1 | UVECOAT | IRGACURE 819 | — | 0.4 | 24.0 |
| | 2000 | 3.5 | — | | |
| | 72.1 | | | | |
| U2 | UVECOAT | IRGACURE 819 | RX | 0.4 | 24.0 |
| | 2000 | 3.5 | 05613 | | |
| | 72.1 | | 4.0 | | |

TABLE 5
Properties of UV Curable Powder Coatings

| Formulation Number | | U1 | U2 |
|---|---|---|---|
| Gloss | 60° | 95.0 | 99.0 |
| | 20° | 84.0 | 92.0 |
| Haze | | 99.0 | 40.0 |
| DOI | | 50 | 60 |
| Pencil | scratch | F | 3H |
| Hardness | gauge | 2H | 4H |

| | | |
|---|---|---|
| MEK double rubs | 65 | 140 |

We claim:

1. A powder coating composition comprising reactive nanoparticles and one or more thermocurable or radiation curable resins.

2. The powder coating composition according to claim 1 wherein reactive groups are chemically bonded to the surface of the nanoparticles.

3. The powder coating composition according to claim 2 which are inorganic nanoparticles having reactive groups chemically bonded to the surface thereof.

4. The powder coating composition according to claim 1 wherein a mixture of resin and nanoparticles is melt extruded, cooled and is then subdivided to form the powder coating composition.

5. The powder coating composition according to claim 1 wherein the nanoparticles are blended with resin and the resultant mixture is melted, cooled and subdivided to form the powder coating composition.

6. The powder coating composition according to claim 1 wherein the resin is selected from the group consisting of saturated or unsaturated polyester resins, acrylic or methacrylic resins, epoxy resins, acrylate or methacrylate resins and vinyl functional resins.

7. The powder coating according to claim 2 wherein the reactive groups are at least one of epoxy, carboxyl, hydroxyl, anhydride (carboxylic), vinyl, acrylate or methacrylate groups.
